(19) United States
(12) Patent Application Publication
(10) Pub. No.: US 2019/0319245 A1
(43) Pub. Date: Oct. 17, 2019

(54) SEPARATOR AND LITHIUM ION BATTERY

(71) Applicant: Ningde Amperex Technology Limited, Ningde (CN)

(72) Inventors: Liangzhen Xiao, Ningde (CN); Kefei Wang, Ningde (CN); Qiao Zeng, Ningde (CN)

(21) Appl. No.: 16/174,385

(22) Filed: Oct. 30, 2018

(30) Foreign Application Priority Data
Apr. 11, 2018 (CN) 201810321780.8

(51) Int. Cl. H01M 2/16; H01M 10/0525

(52) U.S. Cl. CPC H01M 2/1686; H01M 10/0525; H01M 2/166

(57) ABSTRACT

The present application provides a separator and a lithium ion battery, the separator comprises a first porous substrate, a second porous substrate and a third porous substrate, wherein the second porous substrate is arranged between the first porous substrate and the third porous substrate, and a tensile strength of the separator in amachine direction is greater than a tensile strength of the separator in a transverse direction. The use of the separator of the present application can improve the thermal stability and safety performance of the lithium ion battery.

### CROSS-REFERENCE TO RELATED APPLICATION

This application claims priority to and benefits of Chinese Patent Application Serial No. 201810321780.8, filed with the China National Intellectual Property Administration on Apr. 11, 2018, and the entire content of which is incorporated herein by reference.

### FIELD OF THE APPLICATION

The present application relates to the field of battery, in particular, to a separator and lithium ion battery.

### BACKGROUND OF THE APPLICATION

A separator is an important component of the lithium ion battery. In the lithium ion battery, it mainly functions to isolate the positive and negative electrodes, prevents the direct contact and short circuit between the positive and negative electrodes, and also function to conduct lithium ions. Therefore, the performance of the separator greatly affects the overall performance of the lithium ion battery, especially the safety performance. At present, the requirement for rate performance of lithium-ion batteries become higher and higher in pursue of high energy density, resulting in poor thermal stability and safety performance (such as heavy impact resistance) of lithium ion batteries. Therefore, there is an urgent need for a separator that can improve the thermal stability and safety performance (for example, heavy impact resistance) of a lithium ion battery while ensuring the rate performance of the lithium ion battery.

### SUMMARY OF THE APPLICATION

The present application provides a lithium ion battery having a separator composed of a three-layered porous substrate. After comprehensive performance of the different layers of the separator, the thermal stability and safety performance of the lithium ion battery (for example, heavy impact resistance) can be effectively improved by adopting the separator composed of the three-layered porous substrate.

The present application provides a separator comprising a first porous substrate, a second porous substrate and a third porous substrate, wherein the second porous substrate is arranged between the first porous substrate and the third porous substrate, and the tensile strength of the separator in the machine direction is greater than the tensile strength of the separator in the transverse direction.

In the above separator, wherein the tensile strength of the separator in the machine direction is 1000 kgf/m²˜3000 kgf/m².

In the above separator, wherein the tensile strength of the separator in the transverse direction is 20 kgf/m²˜400 kgf/m².

In the above separator, wherein the first porous substrate has a melting point of 150° C. to 350° C., the second porous substrate has a melting point of 110° C. to 150° C., and the third porous substrate has a melting point of 150° C. to 350° C.

In the above separator, wherein the separator has a porosity of 25% to 70%.

In the above separator, wherein the second porous substrate comprises at least one of polyethylene and atactic polypropylene, and the first porous substrate and the third porous substrate respectively and individually comprise one or more of isotactic polypropylene, polyvinylidene fluoride, polyethylene terephthalate, cellulose, polyimide, polyamide, spandex, and polyphthalaldehyde phenyl diamine.

In the above separator, wherein the separator further comprises a porous layer arranged on at least one surface of the separator.

In the above separator, wherein the porous layer comprises a binder and an inorganic particle, thebinder is selected from one or more of vinylidene fluoride-hex afluoropropylene copolymer, vinylidene fluoride-trichloroethylene copolymer, polymethyl methacrylate, polyacrylic acid, polyacrylate, polyacrylonitrile, polyvinylpyrrolidone, polyvinyl acetate, ethylene-vinyl acetate copolymer, polyimide, polyethylene oxide, cellulose acetate, cellulose acetate butyrate, cellulose acetate propionate, cyanoethyl amylopectin, cyanoethyl polyvinyl alcohol, cyanoethyl cellulose, cyanoethyl sucrose, amylopectin, sodium carboxymethyl cellulose, lithium carboxymethyl cellulose, acrylonitrile-styrene-butadiene copolymer, polyvinyl alcohol, polyvinyl ether, polytetrafluoroethylene, polyhexafluoropropylene, styrene-butadiene copolymer and polyvinylidene fluoride.

In the above separator, wherein the inorganic particle is selected from one or more of alumina (Al₂O₃), silica (SiO₂), magnesium oxide (MgO), titanium oxide (TiO₂), hafnium oxide (HfO₂), tin oxide (SnO₂), cerium oxide (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide and barium sulfate.

The present application also provides a lithium ion battery comprising the above separator.

The present application improves the thermal stability and safety performance (e.g. heavy impact resistance) of a lithium ion battery comprising the separator by adopting the separator composed of a three-layered porous substrate (the tensile strength of the separator in the machine direction is greater than the tensile strength of the separator in the transverse direction). Further, providing a porous layer on the surface of the separator can be used to further improve the thermal stability and safety performance of the lithium ion battery.

### BRIEF DESCRIPTION OF THE ACCOMPANYING DRAWINGS

FIG. 1 represents a schematic diagram of a separator composed of three-layered porous substrate.

FIG. 2 represents a schematic diagram of an electrode assembly of a wound structure.

FIG. 3 represents a schematic diagram of an electrode assembly of a stacked structure.

FIG. 4 represents a schematic diagram of a separator composed of three-layered porous substrate having a porous layer.

### DETAILED DESCRIPTION OF THE PREFERRED EXAMPLES

The exemplary embodiments are described in sufficient detail below, but these exemplary embodiments may be implemented in various ways and should not be construed as being limited to the embodiments set forth herein. Rather, these embodiments are provided so that the present application will be thorough and complete and the scope of the present application is fully conveyed to those skilled in the art.

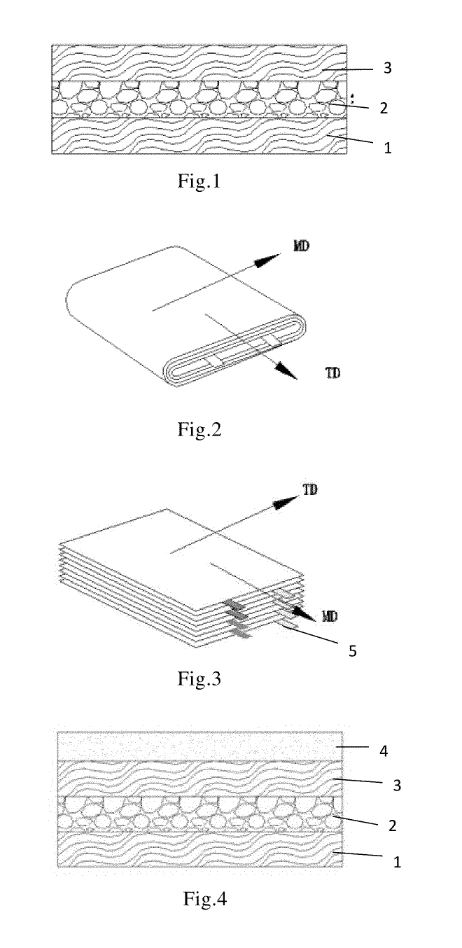

To improve the thermal stability and safety performance (e.g. heavy impact resistance) of the lithium ion battery, the present application provides a mutli-layered composite separator such as three-layered composite separator. As shown in FIG. 1, the separator of the present application comprises a first porous substrate 1, a second porous substrate 2 and a third porous substrate 3, wherein the second porous substrate 2 is arranged between the first porous substrate 1 and the third porous substrate 3.

In some embodiments, the first porous substrate and the third porous substrate respectively and individually comprise one or more of isotactic polypropylene, polyvinylidene fluoride, polyethylene terephthalate (PET), cellulose, polyimide (PI), polyamide (PA), spandex, and polyphthalamide. In some embodiments, the first porous substrate has a melting point of 150° C. to 350° C. and the third porous substrate has a melting point of 150° C. to 350° C. In some embodiments, the second porous substrate comprises one or more of polyethylene and atactic polypropylene. In some embodiments, the second porous substrate has a melting point of 110° C. to 150° C.

In some embodiments, the melting points of the first and third porous substrates are higher than the melting point of the second porous substrate. When heat is generated in the lithium ion battery due to abuse, the temperature inside the lithium ion battery rises to be higher than the melting point of the second porous substrate of the separator, then the holes in the second porous substrate to be closed or the second porous substrate melts to block micropores in the first and third porous substrates of the separator so as to reduce drastically the porosity of the entire separator so that the lithium ions cannot flow between the positive and negative electrodes, thereby cutting off the current, reducing the heat generation, and avoiding the lithium ion battery to ignite or explode by preventing the temperature from rising and therefore improving the safety performance of the lithium ion battery. And since the first and third porous substrates have a high heat-resistant temperature, the shrinkage of the separator can be prevented from causing the positive electrode and the negative electrode to contact and short-circuit.

In some embodiments, the separator of the present application has a porosity of 25% to 70%.

In some embodiments, the tensile strength of the separator of the present application in the machine direction is greater than the tensile strength of the separator in the transverse direction. In some embodiments, the tensile strength of the separator in the machine direction is 1000 kgf/m²˜3000 kgf/m². In some embodiments, the tensile strength of the separator in the transverse direction is 20 kgf/m²˜400 kgf/m². In some embodiments, the electrode assembly of the lithium ion battery is of wound structure shown in FIG. 2; the machine direction refers to the wound direction of the electrode assembly and the transverse direction refers to the direction perpendicular to the machine direction. In some embodiments, the electrode assembly of the lithium ion battery is of stacked or folded structure shown in FIG. 3; the machine direction refers to the direction in which an electrode tab 5 is drawn and the transverse direction refers to the direction perpendicular to the machine direction.

In some embodiments, the tensile strength of the separator is related to the safety performance of the lithium ion battery, and the tensile strength of the separator in the machine direction is greater than the tensile strength of the separator in the transverse direction. When the lithium ion battery is impact by heavy objects, the lower the tensile strength of the separator in the transverse direction, the easier it is to break, while the better the uniformity of the fracture of the lithium ion battery, the less the burr of the fracture, so that the direct contact of the electrodes in the battery are prevented to cause the battery to ignite, thereby improving the safety performance of the lithium ion battery.

In some embodiments, the separator of the present application further comprises a porous layer arranged on at least one surface of the separator. With reference to FIG. 4, FIG. 4 shows a schematic diagram of a composite multi-layered separator containing a porous layer 4. Of course, the structure of the separator shown in FIG. 4 is merely exemplary, and the porous layer 4 may be arranged on the surface of the separator adjacent to the first porous substrate 1, or the porous layer 4 may be provided on the surface of the separator adjacent to the first porous substrate 1 and the third porous substrate 3.

In some embodiments, the porous layer 4 comprises a binder and an inorganic particle. The binder is selected from one or more of vinylidene fluoride-hexafluoropropylene copolymer, vinylidene fluoride-trichloroethylene copolymer, polymethyl methacrylate, polyacrylic acid, polyacrylate, polyacrylonitrile, polyvinylpyrrolidone, polyvinyl acetate, ethylene-vinylidene acetate copolymer, polyimide, polyethylene oxide, cellulose acetate, cellulose acetate butyrate, cellulose acetate propionate, cyanoethyl amylopectin, cyanoethyl polyvinyl alcohol, cyanoethyl cellulose, cyanoethyl sucrose, amylopectin, sodium carboxymethyl cellulose, lithium carboxymethyl cellulose, acrylonitrile-styrene-butadiene copolymer, polyvinyl alcohol, polyvinyl ether, polytetrafluoroethylene, polyhexafluoropropylene, styrene-butadiene copolymer and polyvinylidene fluoride. The binder may provide a sufficient bonding interface to the electrodes, ensuring high adhesion of the separator to the electrodes for allowing the lithium ion battery to have a higher safety performance.

The inorganic particle is selected from one or more of alumina (Al₂O₃), silica (SiO₂), magnesium oxide (MgO), titanium oxide (TiO₂), hafnium oxide (HfO₂), tin oxide (SnO₂), cerium oxide (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide and barium sulfate. The inorganic particle may play a good mechanical support role for the porous layer so as to prevent the porous layer from undergoing compression collapse during the processing of the lithium ion battery, and the presence of the inorganic particle may improve the heat shrinkage performance of the separator.

When the lithium ion battery is impact by a heavy object, the porous layer can slide relative to the surface of the separator for reducing the risk of the separator being broken, at the same time, the presence of inorganic particle in the porous layer increases the mechanical strength of the separator for improving the anti-impact safety performance of the separator and improving the safety performance of the lithium ion battery. The lithium ion battery further comprises a positive electrode, a negative electrode and an electrolyte, wherein the separator of the present application is inserted between the positive electrode and the negative electrode. The positive current collector may be an aluminum foil or a nickel foil, and the negative current collector may be a copper foil or a nickel foil.

In the above lithium ion battery, the positive electrode comprises a positive electrode material (hereinafter, sometimes referred to as “positive electrode material capable of intercalating and deintercalating lithium Li”) capable of intercalating and deintercalating lithium (Li). Examples of the positive electrode material capable of intercalating and deintercalating lithium Li may comprise one or more of lithium cobaltate, lithium nickel cobalt manganese oxide, lithium nickel cobalt aluminate oxide, lithium manganese oxide, lithium ferromanganese phosphate, lithium vanadium phosphate, lithium vanadium phosphate oxide, lithium iron phosphate, lithium titanate, and lithium-rich manganese-based materials.

In the above positive electrode material, the chemical formula of lithium cobaltate may be LiₓCoₐM1_{b}O_{2-c}, wherein M1 represents at least one selected from the group consisting of nickel (Ni), manganese (Mn), magnesium (Mg), aluminum (Al), boron (B), titanium (Ti), vanadium (V), chromium (Cr), iron (Fe), copper. (Cu), zinc (Zn), molybdenum (Mo), tin (Sn), calcium (Ca), strontium (Sr), tungsten (W), yttrium (Y), lanthanum (La), zirconium (Zr), and silicon, and the values of x, a, b and c are respectively in the following ranges: 0.8≤x≤1.2, 0.8≤a≤1, 0≤b≤0.2, −0.1≤c≤0.2;

In the above positive electrode material, the chemical formula of lithium nickel cobalt manganese oxide or lithium nickel cobalt aluminate oxide may be Li_{y}Ni_{d}M2ₑO_{2-f}, wherein M2 represents at least one selected from the group consisting of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), zirconium (Zr) and silicon (Si), and the values of y, d, e and f are respectively in the following ranges: 0.8≤y≤1.2, 0.3≤d≤0.98, 0.02≤e≤0.7, −0.1≤f≤0.2;

In the above positive electrode material, the chemical formula of lithium manganese oxide may be Li_{z}Mn_{2-g}M_{3g}O₄₋ₕ, wherein M3 represents at least one selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W), and the values of z, g, and h are respectively in the following ranges: 0.8≤z≤1.2, 0≤g≤1.0 and −0.2≤h≤0.2.

The negative electrode comprises a negative electrode material (hereinafter, sometimes referred to as “negative electrode material capable of intercalating/deintercalating lithium Li”) capable of intercalating and deintercalating lithium (Li). Examples of the negative electrode material capable of intercalating and deintercalating lithium Li may comprise carbon materials, metal compounds, oxides, sulfides, nitrides of lithium such as LiN₃, lithium metal, metals which form alloys together with lithium and polymer materials.

Examples of carbon materials may comprise low graphitized carbon, easily graphitizable carbon, artificial graphite, natural graphite, mesocarbon microbeads, soft carbon, hard carbon, pyrolytic carbon, coke, vitreous carbon, organic polymer compound sintered body, carbon fiber and activated carbon. Among them, coke may comprise pitch coke, needle coke, and petroleum coke. The organic polymer compound sintered body refers to a material obtained by calcining a polymer material such as a phenol plastic or a furan resin at a suitable temperature for carbonizing, and some of these materials are classified into low graphitized carbon or easily graphitizable carbon. Examples of the polymer material may comprise polyacetylene and polypyrrole.

Further, in the negative electrode material capable of intercalating and deintercalating lithium (Li), a material whose charging and discharging voltages are close to the charging and discharging voltages of lithium metal is selected. This is because the lower the charging and discharging voltage of the negative electrode material, the easier the battery is to have a higher energy density. Among them, the negative electrode material may be selected from carbon materials because their crystal structures are only slightly changed upon charging and discharging, and therefore, good cycle characteristics as well as large charge and discharge capacities may be obtained. In particular, graphite may be selected because it gives a large electrochemical equivalent and a high energy density.

In addition, the negative electrode material capable of intercalating and deintercalating lithium (Li) may comprise elemental lithium metal, metal elements and semimetal elements capable of forming an alloy together with lithium (Li), and alloys and compounds of such elements. In particular, they are used together with carbon materials because in this case, good cycle characteristics as well as high energy density may be obtained. In addition to alloys comprising two or more metal elements, the alloys used herein also comprise alloys comprising one or more metal elements and one or more semi-metal elements. The alloy may be in the form of a solid solution, a eutectic crystal (eutectic mixture), an intermetallic compound, and a mixture thereof.

Examples of the metal element and the semi-metal element may comprise tin (Sn), plumbum (Pb), aluminum (Al), indium (In), silicon (Si), zinc (Zn), antimony (Sb), bismuth (Bi), Cadmium (Cd), magnesium (Mg), boron (B), gallium (Ga), germanium (Ge), arsenic (As), silver (Ag), zirconium (Zr), yttrium (Y), and hafnium (Hf). Examples of the above alloys and compounds may comprise a material having a chemical formula MaₛMbₜLiᵤ and a material having a chemical formula MaₚMc_{q}Mdᵣ. In these chemical formulae, Ma denotes at least one of a metal element and a semi-metal element capable of forming an alloy together with lithium; Mb denotes at least one of a metal element and a semi-metal element other than lithium and Ma; Mc denotes at least one of the non-metallic elements; Md denotes at least one of a metal element and a semi-metal element other than Ma; and s, t, u, p, q and r meet s>0, t≥0, u≥0, p>0, q>0 and r≥0.

Further, an inorganic compound not comprising lithium (Li) such as MnO₂, V₂O₅, V₆O₁₃, NiS, and MoS may be used in the negative electrode.

The above lithium ion battery further comprises an electrolyte which may be one or more of a gel electrolyte, a solid electrolyte and an electrolytic solution, and the electrolytic solution comprises a lithium salt and a non-aqueous solvent.

The lithium salt comprises one or more selected from the group consisting of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, and lithium difluoroborate. For example, the lithium salt selects LiPF₆ because it may give high ionic conductivity and improved cycle characteristics.

The non-aqueous solvent may be a carbonate compound, a carboxylate compound, an ether compound, other organic solvents, or a combination thereof.

The carbonate compound may be a chain carbonate compound, a cyclic carbonate compound, a fluorocarbonate compound, or a combination thereof.

Examples of the chain carbonate compound are diethyl carbonate (DEC), dimethyl carbonate (DMC), dipropyl carbonate (DPC), methylpropyl carbonate (MPC), ethylene propyl carbonate (EPC), and methyl ethyl carbonate (MEC) and combinations thereof. Examples of the cyclic carbonate compound are ethylene carbonate (EC), propylene carbonate (PC), butylene carbonate (BC), vinylidene ethylene carbonate (VEC), and combinations thereof. Examples of the fluorocarbonate compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, and combinations thereof.

Examples of the carboxylate compound are methyl acetate, ethyl acetate, n-propyl acetate, t-butyl acetate, methyl propionate, ethyl propionate, γ-butyrolactone, azlactone, valerolactone, mevalonolactone, caprolactone, methyl formate and combinations thereof.

Examples of the ether compounds are dibutyl ether, tetraglyme, diglyme, 1,2-dimethoxyethane, 1,2-diethoxyethane, ethoxymethoxyethane, 2-methyltetrahydrofuran, tetrahydrofuran, and combinations thereof.

Examples of other organic solvents are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate and phosphate, and combinations thereof.

The positive electrode, the separator, the negative electrode are sequentially wound or folded into an electrode assembly, and then sealed (for example, in an aluminum plastic film) for encapsulation, and injected with an electrolyte for formation and packaging, thus a lithium ion battery is made.

Those skilled in the art will appreciate that the above described methods for preparing the lithium ion battery are merely examples. Other methods commonly used in the art may be employed without departing from the disclosure of the present application.

The following description is made in conjunction with specific examples to better understand the present application.

### Example 1

(1) Preparation of the Negative Electrode

A solvent of deionized water and a thickener of sodium carboxymethyl cellulose (CMC) are added to a stirring mill to dissolve completely under vacuum to obtain an aqueous polymer solution; then, a conductive agent of conductive carbon black is added to the aqueous polymer solution, and stirred to be uniform; then a negative electrode material of artificial graphite is added and stirred slowly under vacuum to be uniform; then, a binder of styrene-butadiene rubber is added, and is slowly stirred under vacuum to be uniform to obtain a negative electrode slurry; subsequently, the negative electrode slurry is uniformly coated on both sides of a negative electrode current collector of copper foil, and after drying, a negative electrode material layer is obtained, and then compacted by a roll press, and finally cut and welded with an electrode tab, so as to obtain the negative electrode of the lithium ion battery. Among them, the mass ratio of the negative electrode material, the conductive agent, the binder, and the thickener is 94.5:1.5:2:2.

(2) Preparation of the Positive Electrode

A solvent of N-methylpyrrolidone (NMP) and a binder of polyvinylidene fluoride (PVDF) are added to a stirring mill to dissolve completely under vacuum to obtain a polyvinylidene fluoride solution; then, a conductive agent of conductive carbon black is added to the polyvinylidene fluoride solution, and stirred rapidly to be uniform; then a positive electrode material of lithium cobaltate (LiCoO₂) is added and stirred slowly under vacuum to be uniform to obtain a positive electrode slurry; subsequently, the positive electrode slurry is uniformly coated on both sides of a positive electrode current collector of aluminum foil, and compacted by a roll press, and finally cut and welded with an electrode tab, so as to obtain the positive electrode of the lithium ion battery. Among them, the mass ratio of the positive electrode material, the binder and the conductive agent is 92:4:4.

(3) Preparation of Electrolyte

In an argon atmosphere glove box with a water content of <10 ppm, ethylene carbonate (EC), propylene carbonate (PC), and dimethyl carbonate (DEC) are mixed in a volume ratio of EC:PC:DEC=1:1:1, followed by dissolving the fully dried lithium salt LiPF₆ in a mixed organic solvent and uniformly mixing to obtain a liquid electrolyte (electrolytic solution), wherein the concentration of LiPF₆ is 1M.

(4) Preparation of Separator

A first porous substrate (isotactic polypropylene PP having a melting point of 163° C. to 167° C., a tensile strength in machine direction of 1030 kgf/cm², a tensile strength in transverse direction of 802 kgf/cm²), a second porous substrate (polyethylene PE having a melting point of 118° C. to 122° C., a tensile strength in machine direction of 810 kgf/cm² and a tensile strength in transverse direction of 707 kgf/cm²) and a third porous substrate (isotactic polypropylene PP with a melting point of 163° C. to 167° C., a tensile strength in machine direction of 1030 kgf/cm² and a tensile strength in transverse direction of 802 kgf/cm²) are provided. The second porous substrate is arranged between the first and third porous substrates, and is hot-pressed together to obtain a separator, wherein the hot pressing temperature is controlled at 90° C., and the hot pressing pressure is controlled at 1.0 MPa. Among them, the separator has a tensile strength in the machine direction of 890 kgf/cm², a tensile strength in the transverse direction of 730 kgf/cm², and a porosity of 30%.

(5) Preparation of Lithium Ion Battery

The positive electrode, the separator and the negative electrode are stacked in order so that the separator is in a role of isolation between the positive electrode and the negative electrode, and then are wound to obtain an electrode assembly; the electrode assembly is placed in a packaging shell with aluminum plastic film, and the prepared electrolyte is injected into the dried electrode assembly, and then subjected to processes such as vacuum encapsulation, static crystallization, formation, capacity testing, shaping to obtain a lithium ion battery.

### Example 2

The preparation process of the lithium ion battery is the same as that in Example 1, except that:

(4) Preparation of Separator

The first porous substrate has a tensile strength in machine direction of 829 kgf/cm², a tensile strength in transverse direction of 700 kgf/cm², and the second porous substrate has a tensile strength of 800 kgf/cm² and a tensile strength in transverse direction of 627 kgf/cm²; the third porous substrate is polyvinylidene fluoride PVDF having a melting point of 170° C. to 172° C., a tensile strength in machine direction of 610 kgf/cm² and a tensile strength in transverse direction of 550 kgf/cm²; the tensile strength of the separator in the machine direction is 773 kgf/cm², and the tensile strength of the separator in the transverse direction is 624 kgf/cm².

### Example 3

The preparation process of the lithium ion battery is the same as that in Example 1, except that:

(4) Preparation of Separator

The first porous substrate is polyvinylidene fluoride PVDF having a melting point of 169° C. to 172° C., a tensile strength in machine direction of 610 kgf/cm², a tensile strength in transverse direction of 400 kgf/cm², and the second porous substrate has a tensile strength n machine direction of 467 kgf/cm² and a tensile strength in transverse direction of 627 kgf/cm²; the third porous substrate is polyvinylidene fluoride PVDF having a melting point of 169° C. to 172° C., a tensile strength in machine direction of 610 kgf/cm² and a tensile strength in transverse direction of 400 kgf/cm²; the tensile strength of the separator in the machine direction is 545 kgf/cm², and the tensile strength of the separator in the transverse direction is 483 kgf/cm².

### Example 4

The preparation process of the lithium ion battery is the same as that in Example 1, except that:

(4) Preparation of Separator

The first porous substrate has a tensile strength in machine direction of 942 kgf/cm², a tensile strength in transverse direction of 700 kgf/cm², and the second porous substrate is atactic polypropylene PP having a melting point of 112° C. to 114° C., a tensile strength in machine direction of 820 kgf/cm² and a tensile strength in transverse direction of 630 kgf/cm²; the third porous substrate has a tensile strength in machine direction of 942 kgf/cm² and a tensile strength in transverse direction of 700 kgf/cm²; the tensile strength of the separator in the machine direction is 923 kgf/cm², and the tensile strength of the separator in the transverse direction is 684 kgf/cm².

### Example 5

The preparation process of the lithium ion battery is the same as that in Example 1, except that:

(4) Preparation of Separator

The first porous substrate is polyamide PA having a melting point of 230° C. to 234° C., a tensile strength in machine direction of 370 kgf/cm², a tensile strength in transverse direction of 411 kgf/cm², and the second porous substrate is atactic polypropylene PP having a melting point of 110° C. to 113° C., a tensile strength in machine direction of 620 kgf/cm² and a tensile strength in transverse direction of 530 kgf/cm²; the third porous substrate is polyimide PI having a melting point of 318° C. to 320° C., a tensile strength in machine direction of 400 kgf/cm² and a tensile strength in transverse direction of 380 kgf/cm²; the tensile strength of the separator in the machine direction is 475 kgf/cm², and the tensile strength of the separator in the transverse direction is 446 kgf/cm².

### Example 6

The preparation process of the lithium ion battery is the same as that in Example 1, except that:

(4) Preparation of Separator

The first porous substrate has a tensile strength in machine direction of 1200 kgf/cm², a tensile strength in transverse direction of 800 kgf/cm², and the second porous substrate has a tensile strength in machine direction of 800 kgf/cm² and a tensile strength in transverse direction of 627 kgf/cm²; the third porous substrate has a tensile strength in machine direction of 1200 kgf/cm² and a tensile strength in transverse direction of 800 kgf/cm²; the tensile strength of the separator in the machine direction is 1000 kgf/cm², the tensile strength of the separator in the transverse direction is 721 kgf/cm², and the porosity of the separator is 35%.

### Example 7

The preparation process of the lithium ion battery is the same as that in Example 1, except that:

(4) Preparation of Separator

The first porous substrate has a tensile strength in machine direction of 2130 kgf/cm², a tensile strength in transverse direction of 670 kgf/cm², and the second porous substrate has a tensile strength in machine direction of 1820 kgf/cm² and a tensile strength in transverse direction of 557 kgf/cm²; the third porous substrate has a tensile strength in machine direction of 2130 kgf/cm² and a tensile strength in transverse direction of 670 kgf/cm²; the tensile strength of the separator in the machine direction is 1912 kgf/cm², the tensile strength of the separator in the transverse direction is 628 kgf/cm², and the porosity of the separator is 35%.

### Example 8

The preparation process of the lithium ion battery is the same as that in Example 1, except that:

(4) Preparation of Separator

The first porous substrate has a tensile strength in machine direction of 1810 kgf/cm², a tensile strength in transverse direction of 1412 kgf/cm², and the second porous substrate has a tensile strength in machine direction of 1662 kgf/cm² and a tensile strength in transverse direction of 1100 kgf/cm²; the third porous substrate has a tensile strength in machine direction of 1810 kgf/cm² and a tensile strength in transverse direction of 1412 kgf/cm²; the tensile strength of the separator in the machine direction is 1702.6 kgf/cm², the tensile strength of the separator in the transverse direction is 1296.3 kgf/cm², and the porosity of the separator is 35%.

### Example 9

The preparation process of the lithium ion battery is the same as that in Example 1, except that:

(4) Preparation of Separator

The first porous substrate has a tensile strength in machine direction of 790 kgf/cm², a tensile strength in transverse direction of 230 kgf/cm², and the second porous substrate has a tensile strength in machine direction of 761 kgf/cm² and a tensile strength in transverse direction of 102 kgf/cm²; the third porous substrate has a tensile strength in machine direction of 790 kgf/cm² and a tensile strength in transverse direction of 230 kgf/cm²; the tensile strength of the separator in the machine direction is 780 kgf/cm², the tensile strength of the separator in the transverse direction is 182 kgf/cm², and the porosity of the separator is 40%.

### Example 10

The preparation process of the lithium ion battery is the same as that in Example 1, except that:

(4) Preparation of Separator

The first porous substrate has a tensile strength in machine direction of 592 kgf/cm², a tensile strength in transverse direction of 350 kgf/cm², and the second porous substrate has a tensile strength in machine direction of 514 kgf/cm² and a tensile strength in transverse direction of 301 kgf/cm²; the third porous substrate has a tensile strength in machine direction of 592 kgf/cm² and a tensile strength in transverse direction of 350 kgf/cm²; the tensile strength of the separator in the machine direction is 560 kgf/cm², the tensile strength of the separator in the transverse direction is 320.1 kgf/cm², and the porosity of the separator is 40%.

### Example 11

The preparation process of the lithium ion battery is the same as that in Example 1, except that:

(4) Preparation of Separator

The first porous substrate has a tensile strength in machine direction of 713 kgf/cm², a tensile strength in transverse direction of 440 kgf/cm², and the second porous substrate has a tensile strength in machine direction of 601 kgf/cm² and a tensile strength in transverse direction of 351 kgf/cm²; the third porous substrate has a tensile strength in machine direction of 713 kgf/cm² and a tensile strength in transverse direction of 440 kgf/cm²; the tensile strength of the separator in the machine direction is 680 kgf/cm², the tensile strength of the separator in the transverse direction is 400 kgf/cm², and the porosity of the separator is 40%.

### Example 12

The preparation process of the lithium ion battery is the same as that in Example 1, except that:

(4) Preparation of Separator

The first porous substrate has a tensile strength in machine direction of 470 kgf/cm², a tensile strength in transverse direction of 55 kgf/cm², and the second porous substrate has a tensile strength in machine direction of 373 kgf/cm² and a tensile strength in transverse direction of 210 kgf/cm²; the third porous substrate has a tensile strength in machine direction of 470 kgf/cm² and a tensile strength in transverse direction of 55 kgf/cm²; the tensile strength of the separator in the machine direction is 413 kgf/cm², the tensile strength of the separator in the transverse direction is 97.7 kgf/cm², and the porosity of the separator is 40%.

### Example 13

The preparation process of the lithium ion battery is the same as that in Example 1, except that:

(4) Preparation of Separator

The first porous substrate has a tensile strength in machine direction of 1630 kgf/cm², a tensile strength in transverse direction of 212 kgf/cm², and the second porous substrate has a tensile strength in machine direction of 1170 kgf/cm² and a tensile strength in transverse direction of 103 kgf/cm²; the third porous substrate has a tensile strength in machine direction of 1630 kgf/cm² and a tensile strength in transverse direction of 212 kgf/cm²; the tensile strength of the separator in the machine direction is 1479.9 kgf/cm², the tensile strength of the separator in the transverse direction is 182 kgf/cm², and the porosity of the separator is 35%.

### Example 14

The preparation process of the lithium ion battery is the same as that in Example 1, except that:

(4) Preparation of Separator

The first porous substrate has a tensile strength in machine direction of 1501 kgf/cm², a tensile strength in transverse direction of 390 kgf/cm², and the second porous substrate has a tensile strength in machine direction of 1307 kgf/cm² and a tensile strength in transverse direction of 280 kgf/cm²; the third porous substrate has a tensile strength in machine direction of 1501 kgf/cm² and a tensile strength in transverse direction of 390 kgf/cm²; the tensile strength of the separator in the machine direction is 1453 kgf/cm², the tensile strength of the separator in the transverse direction is 346 kgf/cm², and the porosity of the separator is 35%.

### Example 15

The preparation process of the lithium ion battery is the same as that in Example 1, except that:

(4) Preparation of Separator

The first porous substrate has a tensile strength in machine direction of 1410 kgf/cm², a tensile strength in transverse direction of 194 kgf/cm², and the second porous substrate has a tensile strength in machine direction of 1070 kgf/cm² and a tensile strength in transverse direction of 247 kgf/cm²; the third porous substrate has a tensile strength in machine direction of 1410 kgf/cm² and a tensile strength in transverse direction of 194 kgf/cm²; the tensile strength of the separator in the machine direction is 1296.3 kgf/cm², the tensile strength of the separator in the transverse direction is 203 kgf/cm², and the porosity of the separator is 35%.

### Example 16

The preparation process of the lithium ion battery is the same as that in Example 1, except that:

(4) Preparation of Separator

The first porous substrate has a tensile strength in machine direction of 1842 kgf/cm², a tensile strength in transverse direction of 24 kgf/cm², and the second porous substrate has a tensile strength in machine direction of 1971 kgf/cm² and a tensile strength in transverse direction of 16 kgf/cm²; the third porous substrate has a tensile strength in machine direction of 1842 kgf/cm² and a tensile strength in transverse direction of 24 kgf/cm²; the tensile strength of the separator in the machine direction is 1898 kgf/cm², the tensile strength of the separator in the transverse direction is 21 kgf/cm², and the porosity of the separator is 35%.

### Example 17

The preparation process of the lithium ion battery is the same as that in Example 1, except that:

(4) Preparation of Separator

The first porous substrate has a tensile strength in machine direction of 2728 kgf/cm², a tensile strength in transverse direction of 113 kgf/cm², and the second porous substrate has a tensile strength in machine direction of 3007 kgf/cm² and a tensile strength in transverse direction of 84 kgf/cm²; the third porous substrate has a tensile strength in machine direction of 2728 kgf/cm² and a tensile strength in transverse direction of 113 kgf/cm²; the tensile strength of the separator in the machine direction is 2828 kgf/cm², the tensile strength of the separator in the transverse direction is 97.7 kgf/cm², and the porosity of the separator is 35%.

### Example 18

The preparation process of the lithium ion battery is the same as that in Example 1, except that:

(4) Preparation of Separator

The first porous substrate has a tensile strength in machine direction of 1230 kgf/cm², a tensile strength in transverse direction of 436 kgf/cm², and the second porous substrate has a tensile strength in machine direction of 900 kgf/cm² and a tensile strength in transverse direction of 303 kgf/cm²; the third porous substrate has a tensile strength in machine direction of 1230 kgf/cm² and a tensile strength in transverse direction of 436 kgf/cm²; the tensile strength of the separator in the machine direction is 1076 kgf/cm², the tensile strength of the separator in the transverse direction is 387 kgf/cm², and the porosity of the separator is 35%.

### Example 19

The preparation process of the lithium ion battery is the same as that in Example 18, except that:

(4) Preparation of Separator

A porous layer is also formed on one surface of the separator, and the porous layer comprises polyacrylonitrile and aluminum oxide.

### Example 20

The preparation process of the lithium ion battery is the same as that in Example 13, except that:

(4) Preparation of Separator

A porous layer is also formed on both surfaces of the separator, and the porous layer comprises polyacrylonitrile and aluminum oxide.

### Example 21

The preparation process of the lithium ion battery is the same as that in Example 14, except that:

(4) Preparation of Separator

A porous layer is also formed on both surfaces of the separator, and the porous layer comprises polytetrafluoroethylene and silica.

### Example 22

The preparation process of the lithium ion battery is the same as that in Example 15, except that:

(4) Preparation of Separator

A porous layer is also formed on both surfaces of the separator, and the porous layer comprises polytetrafluoroethylene, polyacrylonitrile, and silica.

### Example 23

The preparation process of the lithium ion battery is the same as that in Example 17, except that:

(4) For preparation of separator, a porous layer is also formed on both surfaces of the separator, and the porous layer comprises polytetrafluoroethylene, silica, and alumina.

### Comparative Example 1

The preparation process of the lithium ion battery is the same as that in Example 1, except that:

(4) Preparation of Separator

The first porous substrate has a tensile strength in machine direction of 1400 kgf/cm², a tensile strength in transverse direction of 1400 kgf/cm², and the second porous substrate has a tensile strength in machine direction of 1007 kgf/cm² and a tensile strength in transverse direction of 1007 kgf/cm²; the third porous substrate has a tensile strength in machine direction of 1400 kgf/cm² and a tensile strength in transverse direction of 1007 kgf/cm²; the tensile strength of the separator in the machine direction is 1224 kgf/cm², the tensile strength of the separator in transverse direction is 1224 kgf/cm², and the porosity of the separator is 40%.

### Comparative Example 2

The preparation process of the lithium ion battery is the same as that in Example 1, except that:

(4) Preparation of Separator

The first porous substrate has a tensile strength in machine direction of 1301 kgf/cm², a tensile strength in transverse direction of 1700 kgf/cm², and the second porous substrate has a tensile strength in machine direction of 1570 kgf/cm² and a tensile strength in transverse direction of 1989 kgf/cm²; the third porous substrate has a tensile strength in machine direction of 1301 kgf/cm² and a tensile strength in transverse direction of 1700 kgf/cm²; the tensile strength of the separator in the machine direction is 1436 kgf/cm², the tensile strength of the separator in the transverse direction is 1736 kgf/cm², and the porosity of the separator is 50%.

### Comparative Example 3

The preparation process of the lithium ion battery is the same as that in Example 1, except that:

(4) Preparation of Separator

The first porous substrate has a tensile strength in machine direction of 229 kgf/cm², a tensile strength in transverse direction of 216 kgf/cm², and the second porous substrate has a tensile strength in machine direction of 370 kgf/cm² and a tensile strength in transverse direction of 360 kgf/cm²; the second porous substrate has a tensile strength in machine direction of 229 kgf/cm² and a tensile strength in transverse direction of 216 kgf/cm²; the tensile strength of the separator in the machine direction is 263 kgf/cm², the tensile strength of the separator in the transverse direction is 263 kgf/cm², and the porosity of the separator is 55%.

Next, the test process of the lithium ion battery will be described.

(1) Test for the Tensile Strength of Separator

First, the separator is cut into a sample having a width (W) of 14.5 mm and a length (L) of 100 mm in the machine direction and the transverse direction, respectively, then the separator sample is stretched at a constant rate (v) of 50 mm/min and a clamping distance of 40 mm (S1) using a high-speed tensile machine, and the tensile strengths of the separator in the machine and transverse fractures are recorded separately.

(2) Test for Heat Resistance Performance of Lithium Ion Battery

The lithium-ion battery is placed in a 130° C. hot box for 1 hour, or in a 140° C. hot box for 1 hour, or in a 150° C. hot box for 3 minutes. If the lithium ion battery does not explode, ignite, smoke, it is defined as “Pass”, and five lithium-ion batteries are tested in each group.

(3) Test for Heavy Impact of Lithium Ion Battery

The lithium ion battery is charged at a constant current of 0.5 C to a voltage of 4.3 V at 25° C., and then charged at a constant voltage of 4.3 V to a current of 0.05 C. The UL1642 test standard is adopted, wherein the mass of the hammer is 9.8 kg with a diameter of 15.8 mm, a drop height of 61±2.5 cm and a falling direction parallel to the machine direction of the separator, to perform a heavy impact test on the lithium ion battery. If the lithium ion battery does not explode, ignite, smoke, it is defined as “Pass”, and five lithium-ion batteries are tested in each group. Then the pass rate of the heavy impact test for the lithium ion battery is calculated (if 4 batteries pass the heavy impact test, 415 is expressed).

The test results are shown in Table 1 below.

TABLE 1

| | types of porous substrate | tensile strength | tensile strength | | | | | | |
|---|---|---|---|---|---|---|---|---|---|
| | (the third porous substrate/ | in machine | in transverse | porous | porous | | | | |
| | the second porous substrate/ | direction | direction | layer | layer | 130° C. | 140° C. | 150° C., | heavy |
| Examples | the first porous substrate) | (kgf/cm²) | (kgf/cm²) | structure | composition | 1 h | 1 h | 3 min | impact |
| 1 | PP/PE/PP | 890 | 730 | / | / | 4\|5 | 4\|5 | 3\|5 | 0\|5 |
| 2 | PVDF/PE/PP | 773 | 624 | / | / | 4\|5 | 3\|5 | 3\|5 | 0\|5 |
| 3 | PVDF/PE/PVDF | 545 | 483 | / | / | 4\|5 | 3\|5 | 2\|5 | 1\|5 |
| 4 | PP/PP/PP | 923 | 684 | / | / | 5\|5 | 4\|5 | 3\|5 | 0\|5 |
| 5 | PI/PP/PA | 475 | 446 | / | / | 3\|5 | 2\|5 | 1\|5 | 1\|5 |
| 6 | PP/PE/PP | 1000 | 721 | / | / | 5\|5 | 4\|5 | 4\|5 | 0\|5 |
| 7 | PP/PE/PP | 1912 | 628 | / | / | 5\|5 | 5\|5 | 5\|5 | 1\|5 |
| 8 | PP/PE/PP | 1702.6 | 1296.3 | / | / | 5\|5 | 5\|5 | 5\|5 | 0\|5 |
| 9 | PP/PE/PP | 780 | 182 | / | / | 4\|5 | 3\|5 | 3\|5 | 4\|5 |
| 10 | PP/PE/PP | 560 | 320.1 | / | / | 4\|5 | 3\|5 | 2\|5 | 3\|5 |
| 11 | PP/PE/PP | 680 | 400 | / | / | 4\|5 | 3\|5 | 3\|5 | 2\|5 |
| 12 | PP/PE/PP | 413 | 97.7 | / | / | 3\|5 | 3\|5 | 2\|5 | 4\|5 |
| 13 | PP/PE/PP | 1479.9 | 182 | / | / | 5\|5 | 4\|5 | 4\|5 | 4\|5 |
| 14 | PP/PE/PP | 1453 | 346 | / | / | 5\|5 | 4\|5 | 4\|5 | 3\|5 |
| 15 | PP/PE/PP | 1296.3 | 203 | / | / | 5\|5 | 4\|5 | 4\|5 | 4\|5 |
| 16 | PP/PE/PP | 1898 | 21 | / | / | 5\|5 | 5\|5 | 5\|5 | 4\|5 |
| 17 | PP/PE/PP | 2828 | 97.7 | / | / | 5\|5 | 5\|5 | 5\|5 | 5\|5 |
| 18 | PP/PE/PP | 1076 | 387 | / | / | 5\|5 | 4\|5 | 3\|5 | 2\|5 |
| 19 | PP/PE/PP | 1076 | 387 | one side | Polyacrylonitrile + | 5\|5 | 5\|5 | 5\|5 | 4\|5 |
| | | | | | Al₂O₃ | | | | |
| 20 | PP/PE/PP | 1479.9 | 182 | both sides | Polyacrylonitrile + | 5\|5 | 5\|5 | 5\|5 | 5\|5 |
| | | | | | Al₂O₃ | | | | |
| 21 | PP/PE/PP | 1453 | 346 | both sides | PTFE + SiO₂ | 5\|5 | 5\|5 | 5\|5 | 5\|5 |
| 22 | PP/PE/PP | 1296.3 | 203 | both sides | PTFE + | 5\|5 | 5\|5 | 5\|5 | 5\|5 |
| | | | | | Polyacrylonitrile + | | | | |
| | | | | | SiO₂ | | | | |
| 23 | PP/PE/PP | 1928 | 97.7 | both sides | PTFE + SiO₂ + | 5\|5 | 5\|5 | 5\|5 | 5\|5 |
| | | | | | Al₂O₃ | | | | |

Comparative Examples

| | | | | | | | | | |
|---|---|---|---|---|---|---|---|---|---|
| 1 | PP/PE/PP | 1224 | 1224 | / | / | 3\|5 | 2\|5 | 0\|5 | 0\|5 |
| 2 | PP/PE/PP | 1436 | 1736 | / | / | 3\|5 | 2\|5 | 0\|5 | 0\|5 |
| 3 | PP/PE/PP | 263 | 263 | / | / | 1\|5 | 0\|5 | 0\|5 | 1\|5 |

By comparing Examples 1-5 and Comparative Examples 1-3, it is known that by making the tensile strength of the separator in the machine direction greater than the tensile strength of the separator in the transverse direction, and the thermal stability of lithium ion batteries is significantly improved at temperatures of 130° C., 140° C. and 150° C.

By comparing Examples 6-8 and Comparative Examples 1-3, it is known that by making the tensile strength of the separator in the machine direction greater than the tensile strength of the separator in the transverse direction, and when the tensile strength of the separator in the machine direction is 1000 kgf/m² or more, the thermal stability of lithium ion batteries is improved to some extent at temperatures of 130° C., 140° C. and 150° C., but the pass rate of the heavy impact test for the lithium ion battery is not significantly improved. Thus, it is indicated that the higher the tensile strength of the separator in the machine direction, the better the thermal stability of the lithium ion battery.

By comparing Examples 9-12 and Comparative Examples 1-3, it is known that by making the tensile strength of the separator in the machine direction greater than the tensile strength of the separator in the transverse direction, and when the tensile strength of the separator in the transverse direction is 400 kgf/m² or below, the pass rate of the heavy impact test for the lithium ion battery is significantly improved and the safety performance of the lithium ion battery becomes better.

By comparing Examples 13-18 and Comparative Examples 1-3, it is known that by making the tensile strength of the separator in the machine direction greater than the tensile strength of the separator in the transverse direction, when the tensile strength of the separator in the machine direction is 1000 kgf/m² or more and the tensile strength of the separator in the transverse direction is 400 kgf/m² or less, the thermal stability of the separator is remarkably improved and the thermal stability of the lithium ion battery is improved. When the lithium ion battery is impact by heavy objects, the lower the tensile strength of the separator in transverse direction, the better the uniformity of the fracture of the lithium ion battery, the less the burr of the fracture, so that risk of short circuit failure caused by the electrode burr is low, thereby improving the safety performance of the lithium ion battery.

By comparing Example 19 and Comparative Example 1, it is known that by making the tensile strength of the separator in the machine direction greater than the tensile strength of the separator in the transverse direction, when the tensile strength of the separator in the machine direction is 1000 kgf/m² or more, the tensile strength of the separator in the transverse direction is 400 kgf/m² or less and a porous layer is arranged on a surface of the separator, the thermal stability of the lithium ion battery and the pass rate of the heavy impact test are significantly improved.

By comparing Examples 20-23 and Comparative Examples 1-3, it is known that by making the tensile strength of the separator in the machine direction greater than the tensile strength of the separator in the transverse direction, when the tensile strength of the separator in the machine direction is 1000 kgf/m² or more, the tensile strength of the separator in the transverse direction is 400 kgf/m² or less and a porous layer is arranged on both surfaces of the separator, the thermal stability of the lithium ion battery and the pass rate of the heavy impact test are significantly improved, in particular, the improvement of the pass rate of the heavy impact test for the lithium ion battery is most obvious.

Those skilled in the art will appreciate that the above-described embodiments are merely exemplary embodiments, and various changes, substitutions and changes may be made without departing from the spirit and scope of the present application.

What is claimed is:

1. A separator, comprising:
a first porous substrate;
a second porous substrate; and
a third porous substrate;
wherein the second porous substrate is arranged between the first porous substrate and the third porous substrate, and a tensile strength of the separator in a machine direction is greater than a tensile strength of the separator in a transverse direction.

2. The separator according to claim 1, wherein the tensile strength of the separator in the machine direction is 1000 kgf/m²˜3000 kgf/m².

3. The separator according to claim 1, wherein the tensile strength of the separator in the transverse direction is 20 kgf/m²˜400 kgf/m².

4. The separator according to claim 1, wherein the first porous substrate has a melting point of 150° C. to 350° C., the second porous substrate has a melting point of 110° C. to 150° C., and the third porous substrate has a melting point of 150° C. to 350° C.

5. The separator according to claim 1, wherein the separator has a porosity of 25% to 70%.

6. The separator according to claim 1, wherein the second porous substrate comprises at least one of polyethylene and atactic polypropylene, and the first porous substrate and the third porous substrate respectively comprise one or more of isotactic polypropylene, polyvinylidene fluoride, polyethylene terephthalate, cellulose, polyimide, polyamide, spandex, and polyphthalaldehyde phenyl diamine.

7. The separator according to claim 1, wherein the separator further comprises a porous layer arranged on at least one surface of the separator.

8. The separator according to claim 7, wherein the porous layer comprises a binder and an inorganic particle, the binder is selected from one or more of vinylidenefluoride-hexafluoropropylene copolymer, vinylidene fluoride-trichloroethylene copolymer, polymethyl methacrylate, polyacrylic acid, polyacrylate, polyacrylonitrile, polyvinylpyrrolidone, polyvinyl acetate, ethylene-vinylidene acetate copolymer, polyimide, polyethylene oxide, cellulose acetate, cellulose acetate butyrate, cellulose acetate propionate, cyanoethyl amylopectin, cyanoethyl polyvinyl alcohol, cyanoethyl cellulose, cyanoethyl sucrose, amylopectin, sodium carboxymethyl cellulose, lithium carboxymethyl cellulose, acrylonitrile-styrene-butadiene copolymer, polyvinyl alcohol, polyvinyl ether, polytetrafluoroethylene, polyhexafluoropropylene, styrene-butadiene copolymer and polyvinylidene fluoride.

9. The separator according to claim 8, wherein the inorganic particle is selected from one or more of alumina, silica, magnesium oxide, titanium oxide, hafnium dioxide, tin oxide, cerium oxide, nickel oxide, zinc oxide, calcium oxide, zirconium oxide, yttrium oxide, silicon carbide, boehmite, aluminum hydroxide, magnesium hydroxide, calcium hydroxide and barium sulfate.

10. A lithium ion battery, comprising:
a separator, wherein the separator comprises:
a first porous substrate;
a second porous substrate; and
a third porous substrate;
wherein the second porous substrate is arranged between the first porous substrate and the third porous substrate, and a tensile strength of the separator in a machine direction is greater than a tensile strength of the separator in a transverse direction.

11. The lithium ion battery according to claim 10, wherein the tensile strength of the separator in the machine direction is 1000 kgf/m²˜3000 kgf/m².

12. The lithium ion battery according to claim 10, wherein the tensile strength of the separator in the transverse direction is 20 kgf/m²˜400 kgf/m².

13. The lithium ion battery according to claim 10, wherein the first porous substrate has a melting point of 150° C. to 350° C., the second porous substrate has a melting point of 110° C. to 150° C., and the third porous substrate has a melting point of 150° C. to 350° C.

14. The lithium ion battery according to claim 10, wherein the separator has a porosity of 25% to 70%.

15. The lithium ion battery according to claim 10, wherein the second porous substrate comprises at least one of polyethylene and atactic polypropylene, and the first porous substrate and the third porous substrate respectively comprise one or more of isotactic polypropylene, polyvinylidene fluoride, polyethylene terephthalate, cellulose, polyimide, polyamide, spandex, and polyphthalaldehyde phenyl diamine.

16. The lithium ion battery according to claim 10, wherein the separator further comprises a porous layer arranged on at least one surface of the separator.

17. The lithium ion battery according to claim 16, wherein the porous layer comprises a binder and an inorganic particle, the binder is selected from one or more of vinylidene fluoride-hexafluoropropylene copolymer, vinylidene fluoride-trichloroethylene copolymer, polymethyl methacrylate, polyacrylic acid, polyacrylate, polyacrylonitrile, polyvinylpyrrolidone, polyvinyl acetate, ethylene-vinylidene acetate copolymer, polyimide, polyethylene oxide, cellulose acetate, cellulose acetate butyrate, cellulose acetate propionate, cyanoethyl amylopectin, cyanoethyl polyvinyl alcohol, cyanoethyl cellulose, cyanoethyl sucrose, amylopectin, sodium carboxymethyl cellulose, lithium carboxymethyl cellulose, acrylonitrile-styrene-butadiene copolymer, polyvinyl alcohol, polyvinyl ether, polytetrafluoroethylene, polyhexafluoropropylene, styrene-butadiene copolymer and polyvinylidene fluoride.

18. The lithium ion battery according to claim 17, wherein the inorganic particle is selected from one or more of alumina, silica, magnesium oxide, titanium oxide, hafnium dioxide, tin oxide, cerium oxide, nickel oxide, zinc oxide, calcium oxide, zirconium oxide, yttrium oxide, silicon carbide, boehmite, aluminum hydroxide, magnesium hydroxide, calcium hydroxide and barium sulfate.
